(19) United States
(12) Patent Application Publication
(10) Pub. No.: US 2009/0255992 A1
(43) Pub. Date: Oct. 15, 2009

(54) System for Synthesizing a Two Dimensional Code and a Logo and the Method Thereof

(75) Inventor: Wei Shen, Beijing (CN)

Correspondence Address: LERNER GREENBERG STEMER LLP, P O BOX 2480, HOLLYWOOD, FL, 33022-2480, US

(73) Assignee: GMEDIA CORPORATION, Grand Cayman (KY)

(21) Appl. No.: 12/295,944

(22) PCT Filed: Mar. 7, 2007
(86) PCT No.: PCT/CN2007/000740

§ 371 Date: Oct. 3, 2008

(30) Foreign Application Priority Data
Apr. 29, 2006 (CN) 200610078994.4

(51) Int. Cl. G06K 7/10; G06K 19/06

(52) U.S. Cl. 235/462.1; 235/494

(57) ABSTRACT

Briefly, a system for synthesizing a two dimensional code and a logo and the method thereof are presented. The system for generating a synthesized two dimensional code comprises synthesizing means, for synthesizing an original two dimensional code and a visually readable logo to form the synthesized two dimensional code, with at least a part of the visually readable logo being overlapped with the original two dimensional code; identifying means, for reading and identifying the synthesized two dimensional code; and adjusting means, if the synthesized two dimensional code being identified by the identifying means has a code error rate of the synthesized two dimensional code larger than an error correction rate, the adjusting means adjusting the size of the visually readable logo and/or the location of the visually readable logo with respect to the original two dimensional code. The present invention may integrate enterprise logo(s), brand logo(s) and product logo(s) with a two dimensional code as a whole, which may save areas and achieve better effect for brand and product promotion.

### TECHNICAL FIELD

The present invention relates to a system for synthesizing a two dimensional code and a logo and the method thereof.

### BACKGROUND

Because of large information capability and strong error-correction ability, two dimensional codes are widely used in the fields of industry management, logistics management and license management. Especially for recent years, the application of shooting a two dimensional code and identifying information encoded therein is in the ascendant globally, due to the popularity of camera mobile phones. A user may obtain personal information and company information by identifying two dimensional codes on business cards with a camera phone; a user may also obtain advertisement URLs and access web sites for more information by identifying two dimensional codes printed on advertisements.

Nowadays, a two dimension code is usually presented as an intact image, and sometimes with some descriptive texts outside the image. However, this approach has difficulty in associating a two dimensional code with an enterprise logo or a product logo, and occupies larger area. As such, an organic association of the two dimensional code with the enterprise or product logo is more desirable, especially for the case of using the two dimensional code as an advertisement link for identifying by mobile phones.

### SUMMARY OF THE INVENTION

With respect to the drawbacks and disadvantages in the prior art, the present invention provides a system for synthesizing a two dimensional code and a logo, and the method thereof, which is able to insert logo(s) into a two dimensional code without impacting the interpretation of the two dimensional code.

To achieve the purpose of the present invention as described above, the present invention employs technical solutions below:

A system for synthesizing a two dimensional code and a logo, comprising:
synthesizing and editing means for synthesizing a two dimensional code and a logo into a new two dimensional code;
adjusting means for adjusting the size of the logo and the location of the logo in the original two dimensional code; and
an identifying terminal for identifying the new two dimensional code;
wherein the identifying terminal reads the new two dimensional code, and control the adjusting means to adjust the size of the logo and the location of the logo in the original two dimensional code, so as to make a code error rate of the new two dimensional code less than its error correction rate.

Preferably, a system for synthesizing a two dimensional code and a logo, the logo comprises the forms of image, graph, text and painting.

Preferably, a system for synthesizing a two dimensional code and a logo, characterized in that the code error rate of the new two dimensional code is a summation of a code error rate of the two dimensional code and a code error rate caused by data code words overlapped by the logo.

A method for synthesizing a two dimensional code and a logo, comprising steps as follow:
(1) editing and synthesizing a new two dimensional code with a two dimensional code and a logo by synthesizing and editing means;
(2) adjusting the size of the logo and the location of the logo in the original two dimensional code by adjusting means;
(3) identifying the new two dimensional code by a identifying terminal, and if a code error rate of the new two dimensional code is less than an error correction rate, then ending this step since the new two dimensional code is able to be identified correctly; else, returning to step (2).

Preferably, a method for synthesizing a two dimensional code and a logo, the code error rate of the new two dimensional code is a summation of a code error rate of the two dimensional code and a code error rate caused by data code words overlapped by the logo.

The present invention may integrate enterprise logo(s), brand logo(s) and product logo(s) with a two dimensional code as a whole, which may save areas and achieve better effect for brand and product promotion.

According to one aspect of the present invention, a system for generating a synthesized two dimensional code is provided, which comprises synthesizing means, for synthesizing an original two dimensional code and a visually readable logo to form the synthesized two dimensional code, with at least a part of the visually readable logo being overlapped with the original two dimensional code; identifying means, for reading and identifying the synthesized two dimensional code; and adjusting means, if the synthesized two dimensional code being identified by the identifying means has a code error rate larger than an error correction rate, the adjusting means adjusting the size of the visually readable logo and/or the location of the visually readable logo in the original two dimensional code.

According to another aspect of the present invention, a method for generating a synthesized two dimensional code is provided, which comprises a) synthesizing an original two dimensional code and a visually readable logo to form the synthesized two dimensional code, with at least a part of the visually readable logo being overlapped with the original two dimensional code; b) reading and identifying the synthesized two dimensional code; c) if the synthesized two dimensional code being identified by the identifying means has a code error rate larger than an error correction rate, adjusting the size of the visually readable logo and/or the location of the visually readable logo in the original two dimensional code; and d) repeating the steps of b) and c), until the code error rate of the synthesized two dimensional code being not larger than the error correction rate.

According to yet another aspect of the present invention, a synthesized two dimensional code is provided, which comprises an original two dimensional code; and a visually readable logo; wherein at least a part of the visually readable logo is overlapped with the original two dimensional code and wherein the synthesized two dimensional code has a code error rate being not larger than an error correction rate. At least a part of the visually readable logo may be overlapped with the data area of the original two dimensional code. The visually readable logo may also be within the data area of the original two dimensional code.

According to various aspects of the present invention, at least a part of the visually readable logo may be overlapped with a data area of the original two dimensional code, and the code error rate is at least a summation of a code error rate of the original two dimensional code and a code error rate caused by the visually readable logo.

According to various aspects of the present invention, the visually readable logo is selected from a group consisting of an image, a graph, a text, a painting, a script and a combination thereof.

### DESCRIPTION OF THE DRAWINGS

In order to understand the manner in which examples of the present invention are obtained, a more particular description of various examples of the invention briefly described above will be rendered by reference to the appended drawings. Understanding that these drawings depict only typical examples of the invention that are not necessarily drawn to scale and are not therefore to be considered to be limited of its scope, the examples of the invention will be described and explained with additional specificity and detail through the use of the accompanying drawings in which:

FIG. 1 is a flow chart of example 1 in accordance with the present invention;

FIG. 2a shows schematic representations of synthesized images of the example 1 of the present invention;

FIG. 2b shows schematic representations of other example synthesized images of the example 1 of the present invention;

FIG. 3 shows two dimensional code patterns in accordance with example 2 of the present invention; and

FIG. 4 is a flow chart showing a method for generating a synthesized two dimensional code in accordance with the present invention.

### DETAILED DESCRIPTION

The present invention is further described in details below, with references made to the figures.

As used here, the term “code error rate (CER)” refers to a rate of the number of code words that being identified incorrectly to the total number of code words encoded in a two dimensional code, and specifically refers to a probability of identifying code words incorrectly. As used here, the term “error correction rate (ECR)” refers to a rate of the number of error code words that may be corrected to the total number of code words encoded in a two dimensional code, which may represent the error correction capability of the two dimensional code. As used here, the term “error correction code percentage (ECC %)” refers to a percentage of the number of error correction code words to the total number of code words encoded in a two dimensional code. For different encoding schemes, the relationship of the ERC and the ECC % differs.

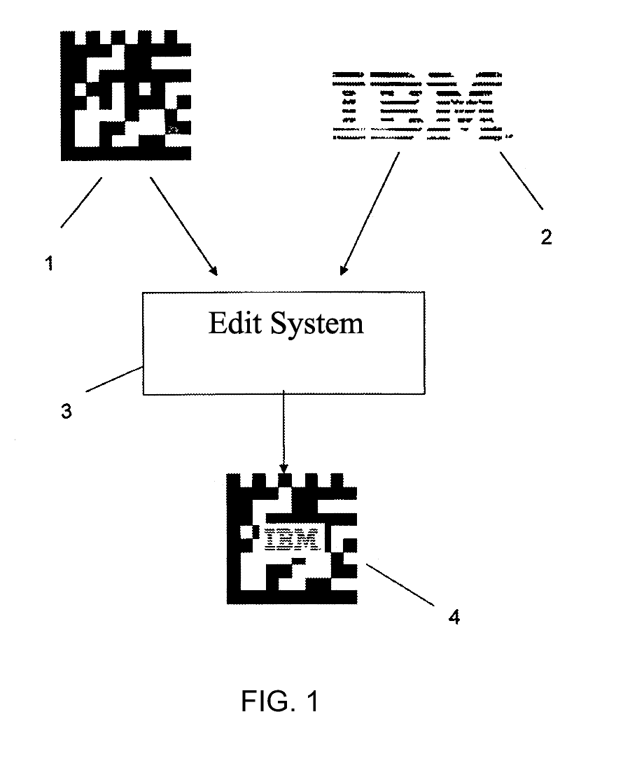

As used here, the term “visually readable logo” refers to a logo that may be seen by a person without optical assisting tools. In FIG. 1, as an example, the logo “IBM” in the synthesized two dimensional code is a visually readable logo only when it has a size big enough for a person's recognition, that may be, for example, a size larger than 10% of the total area of the image of the synthesized two dimensional code.

The present invention provides a system for synthesizing a two dimensional code and a logo and a method thereof, that is, inserting a logo into an image of a two dimensional code such that a part of the image is overlapped with the logo. Since the two dimensional code has the function of error correction, the encoded information of the two dimensional code may be ensured to be identified completely as if a code error rate attributed to the data code words and error-correction code words overlapped with the logo is less than an error correction rate of the two dimensional code, i.e. the inserted logo would not affect the decoding. The error correction rate differs from different types of two dimensional codes, and even some two dimensional codes of the same type may be set with different error correction rate levels while being encoding. In order to be correctly identified, the data code words and error correction code words overlapped with the logo may be more for a two dimensional code with a higher error correction rate and contrarily less for a two dimensional code with a lower error correction rate.

The synthesizing of a two dimensional code and a logo in the present invention may be practiced in either a manual manner or an automatic manner. As for the manual manner, an existing or newly generated two dimensional code is input into a system (or software) capable of graph edit, with an existing or newly generated logo being also input into the system, and a new synthesized image, which may be stored, printed and transmitted, is generated through manual edit by synthesizing the two dimensional code and the logo. The synthesized image generated may be tested by a identifying terminal for whether it can be decoded, and if not, the location of the logo needs to be adjusted and/or the logo size needs to be decreased to reduce the amount of overlapped data code words and/or error correction code words. And then resume the synthesizing operation, until the identifying terminal may decode steadily.

The present invention may also practice the synthesizing of a two dimensional code and a logo in an automatic manner, that is, to replace the identifying terminal in the above mentioned system to a computer that automatically performs the identifying operation. The computer automatically inputs the synthesized image into a decoding program. If the image cannot be interpreted, the computer automatically adjusts the location and the size of the logo, and repeats the decoding and adjusting, until it may decode steadily.

In the present invention, references to a “logo” may include an image, a graph, a text, a painting and any combination thereof.

As mentioned above are just some examples and the present invention is not limited in this respect. For example, the logo may be a script or other kind of identification. Further more, the skilled in the art will understand that the synthesizing of a two dimensional code and a logo in the present invention may be practiced in both a manual manner and an automatic manner, and the present invention is not limited in this respect. The “adjusting the size of a logo” in the present invention may include changing the shape of a logo, which comprises compressing the logo in one dimension or tapering the logo in one direction and other operations familiar to persons skilled in the art. The “adjusting the location of a logo” in the present invention may include rotating and/or shifting the logo with respect to the orienting area of a two-dimensional code.

### EXAMPLE 1

In the system for synthesizing a two dimensional code and a logo in accordance with example 1 of the present invention, the synthesizing is performed manually. The two dimensional code may be a two dimensional code with error correction function, such as a DataMatrix code, whose error correction rates can be acquired from Table 1.

TABLE 1

| | Error Correction Capability | | | | | | |
|---|---|---|---|---|---|---|---|
| | | | Error | | | | |
| Number of | Number | Data | Correction | | | | |
| Code Modules | of Data | Code | Code | | Data Capacity | | |
| Lines/Columns | Areas | Words | Words | ECC % | Numbers | Alphanumerics | Bytes |
| 10 × 10 | 1 | 3 | 5 | 62.5 | 6 | 3 | 1 |
| 12 × 12 | 1 | 5 | 7 | 58.3 | 10 | 6 | 3 |
| 14 × 14 | 1 | 8 | 10 | 55.6 | 16 | 10 | 6 |
| 16 × 16 | 1 | 12 | 12 | 50.0 | 24 | 16 | 10 |
| 18 × 18 | 1 | 18 | 14 | 43.8 | 36 | 25 | 16 |
| 20 × 20 | 1 | 22 | 18 | 45.0 | 44 | 31 | 20 |
| 22 × 22 | 1 | 30 | 20 | 40.0 | 60 | 43 | 28 |
| 24 × 24 | 1 | 36 | 24 | 40.0 | 72 | 52 | 34 |
| 26 × 26 | 1 | 44 | 28 | 38.9 | 88 | 64 | 42 |
| 32 × 32 | 4 | 62 | 36 | 36.7 | 124 | 91 | 60 |
| 36 × 36 | 4 | 86 | 42 | 32.8 | 172 | 127 | 84 |
| 40 × 40 | 4 | 114 | 48 | 29.6 | 228 | 169 | 112 |
| 44 × 44 | 4 | 144 | 56 | 28.0 | 288 | 214 | 142 |
| 48 × 48 | 4 | 174 | 68 | 28.1 | 348 | 259 | 172 |
| 52 × 52 | 4 | 204 | 84 | 29.2 | 408 | 304 | 202 |
| 64 × 64 | 16 | 280 | 112 | 28.6 | 560 | 418 | 278 |
| 72 × 72 | 16 | 368 | 144 | 28.1 | 736 | 550 | 366 |
| 80 × 80 | 16 | 456 | 192 | 29.6 | 912 | 682 | 454 |
| 88 × 88 | 16 | 576 | 224 | 28.0 | 1152 | 862 | 574 |
| 96 × 96 | 16 | 696 | 272 | 28.1 | 1392 | 1042 | 694 |
| 104 × 104 | 16 | 816 | 336 | 29.2 | 1632 | 1222 | 814 |
| 120 × 120 | 36 | 1050 | 408 | 28.0 | 2100 | 1573 | 1048 |
| 132 × 132 | 36 | 1304 | 496 | 27.6 | 2608 | 1954 | 1302 |
| 144 × 144 | 36 | 1558 | 620 | 28.5 | 3116 | 2335 | 1556 |

FIG. 1 illustrates a process of the example 1. A image (1) of a two dimensional code with encoded information and a logo image (2) are input into a system or software (3) capable of graph edit, and a new image (4) of a synthesized two dimensional code, which may be stored, printed and transmitted, is generated through manual edit by synthesizing the two dimensional code and the logo. The new image of the synthesized two dimensional code generated may be tested by a identifying terminal or a decoding software on a PC for whether it can be decoded, and if not, the location of the logo needs to be adjusted and/or the logo size needs to be decreased, so that a code error rate caused by the overlapped data code words and/or error correction code words is less than an error correction rate of the two dimensional code. As shown in the table 1, for a DataMatrix code with 10×10 modules, the ECC % is 62.5%.

According to the RS (Reed-Solomon) Code encoding theory, which is the encoding principle of the DataMatrix code, the error correction rate in this case can be calculated as

$$\frac{5}{( 3 + 5 ) \times 2} = 31.25 \%$$

So if the code error rate is less than 31.25%, the synthesized image may be identified correctly. As for another example, for a DataMatrix code with 14×14 modules, the error correction rate can be calculated as

$$\frac{10}{( 10 + 8 ) \times 2} = 27.78 \%$$

Due to the added logo, the identifying of the synthesized two dimensional code by the identifying terminal may be impacted, such as the code words covered by the logo may not be identified, or the code words partially overlapped with the logo may not be read correctly. If the number of code words that are read in error is larger than the number of errors that may be corrected by the error correction scheme, then the decoding would fail. In this case, the graph edit system or software may decrease the size of the logo to make the logo covering less code words, and/or to move the logo to another location where the optical representation of the code words arrangement is somewhat less affected by the added logo. Repeating the adjusting operation, until the code error rate of the synthesized two dimensional code is not larger than the error correction rate, i.e. 27.78%, the synthesized image may be identified correctly.

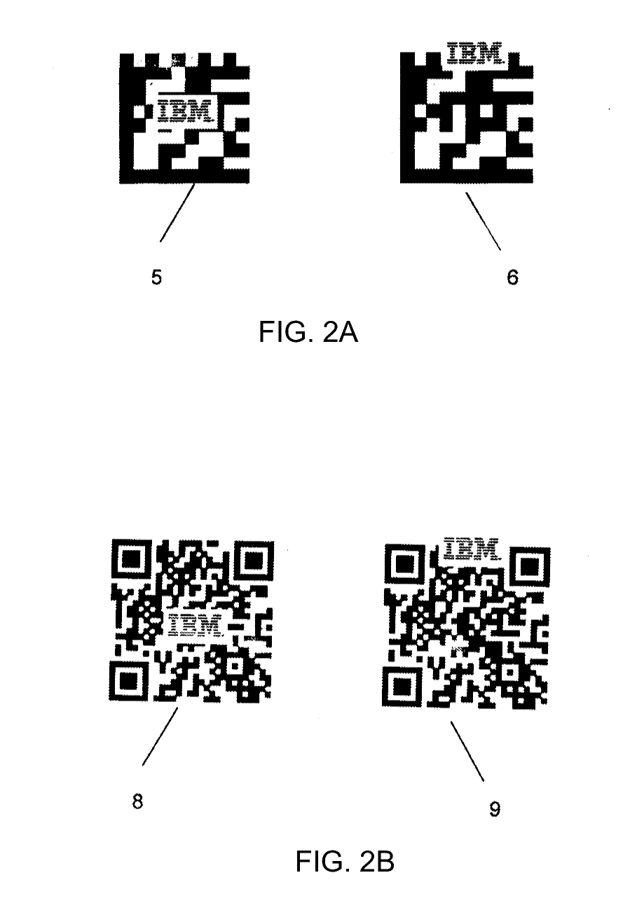

FIG. 2a illustrates examples of synthesized images. The logo image may be fully within the two dimensional code (5), or partially within the two dimensional code (6).

As shown in the FIG. 2a, the DataMatrix code includes an orienting area and a data area. The logo may be fully within the data area, or may be overlapped with both the data area and the orienting area, or even only overlapped with the orienting area. For the case that the logo is only overlapped with the orienting area, the identifying of the synthesized code may not be impacted, with a possible drawback of a slightly larger image. Other manners of overlapping may occur to persons skilled of the art, and the present invention intends to cover all of the variations. According to one embodiment of the present invention, the logo area is larger than 10% of the data area. According to another embodiment of the present invention, the logo area is larger than 20% of the data area. According to yet another embodiment of the present invention, the logo area is larger than 25% of the data area.

FIG. 2b illustrates other examples of synthesized images. As noted above, the logo image may be fully within the two dimensional code (8), or partially within the two dimensional code (9).

### EXAMPLE 2

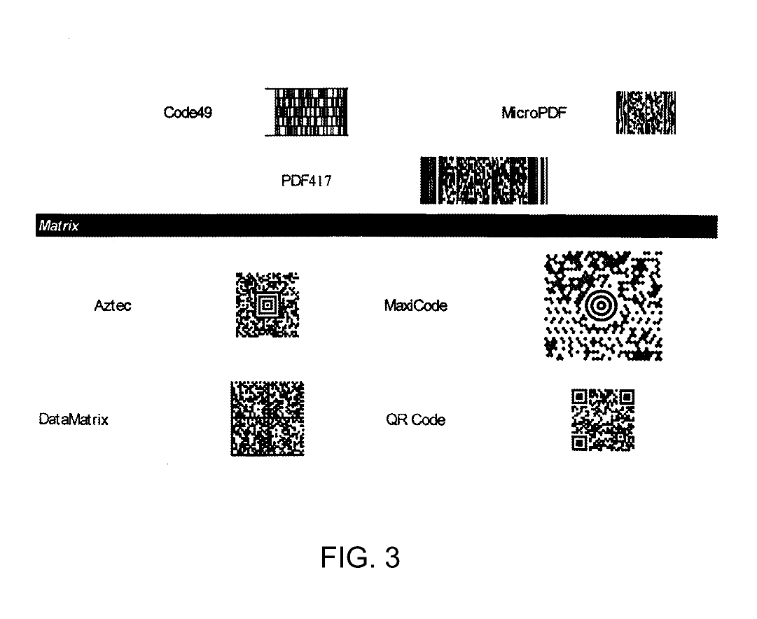

In the system for synthesizing a two dimensional code and a logo in accordance with example 2 of the present invention, the synthesizing is performed automatically. The two dimensional code may be a two dimensional code with the function of error correction, such as a QR Code, a PDF417 Code and the like. FIG. 3 shows patterns of some two dimensional codes with error correction function.

The process of the example 2 is the same as that of the example 1, except for adopting different two dimensional codes, and the principle is also that the synthesized image may be identified when the code error rate caused by the overlapped data code words and/or error correction code words is less than the error correction rate of the two dimensional code. The error correction rates of all the two dimensional codes shown in FIG. 3 have been published and would not be listed herein.

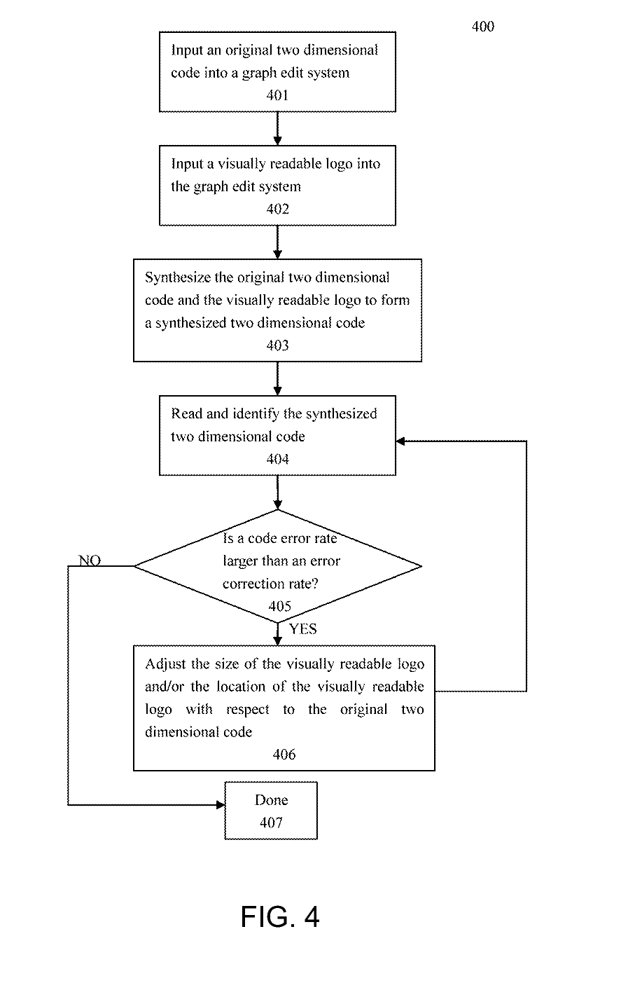

A flow chart of a method 400 for generating a synthesized two dimensional code is shown in FIG. 4. At 401, an original two dimensional code is input into a graph edit system. Then at 402, a visually readable logo is input into the graph edit system. Subsequently, the graph edit system will synthesize the original two dimensional code and the visually readable logo to form a synthesized two dimensional code (403). At 404, the synthesized two dimensional code will be read and identified by identifying means, which may be a computer or a terminal with identifying capability. At this point, a determination should be made about whether the synthesized two dimensional code is identified by the identifying means with a code error rate of the synthesized two dimensional code larger than an error correction rate (405). If the answer is Yes (shown by the ‘YES’), the size of the visually readable logo and/or the location of the visually readable logo in the original two dimensional code are adjusted (406). Then the steps of 405 and 406 are repeated, until the code error rate of the synthesized two dimensional code is not larger than the error correction rate, and the process ends at 407.

The method of FIG. 4 is described in a context that the logo is initially chosen to be bigger than a desired size so that the code error rate of the synthesized two dimensional code is likely larger than the error correction rate. However, the present invention is not so limited. The logo may be initially chosen to be relatively small. In this case, the code error rate of the synthesized two dimensional code may be not larger than the error correction rate at the beginning, and some steps of the method (FIG. 4) may be modified to achieve an optimal visual effect. That is, to increase the size of the logo and/or to adjust the location of the logo, until the code error rate of the synthesized two dimensional code is larger than the error correction rate. Then, the last size/location (where the code error rate of the synthesized two dimensional code is not larger than the error correction rate) may be determined to be the optimal one, and the method ends. Other modifications may also be suitable.

The skilled in the art will appreciate that the inventions are not limited to this chart or to the corresponding description herein. The flow need not move through each illustrated box or exactly in the same order as illustrated and described herein. For example, the steps of 401 and 402 may occur at the same time.

Although some examples are described above to explain the present invention, but the scope of the present invention is not so limited. For example, the logo to be added may be transparent, translucent or opaque for different applications. Further more, the logo may be on a layer with different optical features from the layer on which the two dimensional code lies, with the two layers overlapped together. In this example, as for human's visual effect, the synthesized two dimensional code may be the same as those shown in the Figures, but the identifying means may only be able to read the two dimensional code, instead of both the logo and the two dimensional code, for the optical features of the logo layer. Other implementations still fall into the broad scope of the present invention. It is also apprehensible to persons skilled in the art that the scope of the present invention includes technical solutions in which more than one logo is involved.

Whereas many alterations and modifications of the present invention will no doubt become apparent to a person of ordinary skill in the art after having read the foregoing description, it is to be understood that any particular example shown and described by way of illustration is in no way intended to be considered limiting. Therefore, references to details of various examples are not intended to limit the scope of the claims which in themselves recite only those features regarded as the invention.

What is claimed is:

1. A system for generating a synthesized two dimensional code, comprising:
synthesizing means, for synthesizing an original two dimensional code and a visually readable logo to form the synthesized two dimensional code, with at least a part of the visually readable logo being overlapped with the original two dimensional code;
identifying means, for reading and identifying the synthesized two dimensional code; and
adjusting means, if the synthesized two dimensional code being identified by the identifying means has a code error rate larger than an error correction rate, the adjusting means adjusting the size of the visually readable logo and/or the location of the visually readable logo with respect to the original two dimensional code.

2. The system as claimed in claim 1, wherein at least a part of the visually readable logo is overlapped with the data area of the original two dimensional code.

3. The system as claimed in claim 1, wherein the code error rate is at least a summation of a code error rate of the original two dimensional code and a code error rate caused by the visually readable logo.

4. The system as claimed in claim 1, wherein the visually readable logo is selected from a group consisting of an image, a graph, a text, a painting, a script and a combination thereof.

5. A method for generating a synthesized two dimensional code, comprising:
a) synthesizing an original two dimensional code and a visually readable logo to form the synthesized two dimensional code, with at least a part of the visually readable logo being overlapped with the original two dimensional code;
b) reading and identifying the synthesized two dimensional code;
c) if the synthesized two dimensional code being identified by the identifying means has a code error rate larger than an error correction rate, adjusting the size of the visually readable logo and/or the location of the visually readable logo with respect to the original two dimensional code; and
d) repeating the steps of b) and c), until the code error rate of the synthesized two dimensional code being not larger than the error correction rate.

6. The method as claimed in claim 5, wherein at least a part of the visually readable logo is overlapped with the data area of the original two dimensional code.

7. The method as claimed in claim 5, wherein the code error rate is at least a summation of a code error rate of the original two dimensional code and a code error rate caused by the visually readable logo.

8. A synthesized two dimensional code, comprising:
an original two dimensional code; and
a visually readable logo;
wherein at least a part of the visually readable logo is overlapped with the original two dimensional code, and wherein the synthesized two dimensional code has a code error rate being not larger than an error correction rate.

9. The synthesized two dimensional code as claimed in claim 8, wherein at least a part of the visually readable logo is overlapped with the data area of the original two dimensional code.

10. The synthesized two dimensional code as claimed in claim 9, wherein the visually readable logo is within the data area of the original two dimensional code.
